(19) United States
(12) Patent Application Publication
(10) Pub. No.: US 2018/0020371 A1
(43) Pub. Date: Jan. 18, 2018

(54) AGGREGATING MULTIPLE COMMUNICATION NETWORKS

(71) Applicant: ZAxis Telecom LLC, Atlanta, GA (US)

(72) Inventors: Sunil Dwarka Prasad, Atlanta, GA (US); Rahul Shrivastav, Ranchi (IN)

(21) Appl. No.: 15/212,989

(22) Filed: Jul. 18, 2016

(51) Int. Cl. H04W 28/02; H04J 11/00; H04W 36/00; H04W 36/22; H04W 48/16; H04W 88/06

(52) U.S. Cl. CPC H04W 28/0215; H04W 36/22; H04W 48/16; H04J 11/0083; H04W 36/0066; H04W 88/06

(57) ABSTRACT

Systems and methods are described herein for aggregating network traffic over two or networks via which a mobile device or user equipment (UE) accesses a core network, such as a network providing the Internet and other services to the mobile device. In some embodiments, the systems and methods manage, provision, and/or direct network traffic (e.g., upload or uplink traffic and/or download or downlink traffic) within a communications network to different access networks via a network aggregation node, such as a node placed within an IP layer established between the access networks and the core network.

### BACKGROUND

Dual mode user equipment (UE), such as mobile devices, include various components for accessing network communication services (e.g., voice, message, and/or data communications) over two or more types of networks. For example, a dual mode UE may include multiple different radios to access two different cellular networks (e.g., Global System for Mobile Communications (GSM) networks and Long Term Evolution (LTE) networks), and/or to access both cellular networks (e.g., GSM, LTE) and non-cellular networks, such as Wi-Fi networks (WLAN, WiMAX).

There have been attempts at combining technologies when providing services to mobile device users, in order to utilize the advantages of both types of networks. LTE in Unlicensed Spectrum (LTE-U) and License Assisted Access (LAA) technologies have been established, where cellular networks utilize unlicensed bands in order to increase transmission speeds within a network. 3GPP has also established the LTE-WLAN aggregation (LWA) technology, where LTE and Wi-Fi networks are simultaneously utilized by mobile devices when communication over the network. Also, attempts are being made to aggregate Wi-Fi and LTE networks using IPsec tunneling.

However, the adoption of these solutions presents various drawbacks for both network providers and end users. For example, implementation of LWA may require network providers to upgrade or modify their existing network components. Furthermore, users may only utilize LWA with mobile devices specifically configured to communicate with LWA components. These and other drawbacks exist with respect to the implementation and provision of combined cellular and non-cellular communication services to mobile devices over a network.

### BRIEF DESCRIPTION OF THE DRAWINGS

FIG. 1 illustrates aspects of a suitable network environment that provides network aggregation to mobile devices.

FIGS. 2A-2B are diagrams illustrating the flow of traffic within a network.

FIG. 3 is a flow diagram illustrating a method of directing traffic using a network aggregation node.

FIG. 4 is a signal flow diagram illustrating the flow of signals between components of a communications network.

FIG. 5 is a graph 500 illustrating example results when utilizing the access point for downlink traffic transmission.

### DETAILED DESCRIPTION

Systems and methods are described herein for aggregating network traffic over two or more networks via which a mobile device or user equipment (UE) accesses a core network, such as a network providing the Internet and other services to the mobile device.

In some embodiments, the systems and methods manage, provision, and/or direct network traffic (e.g., upload or uplink traffic and/or download or downlink traffic) within a communications network to different access networks via a network aggregation node, such as a node placed within an IP layer established between the access networks and the core network.

For example, the network aggregation node may intercept a communication message transmitted from a network node or from the dual-mode mobile device to the communications network and determine from the intercepted communication message a network identity and IP address associated with access of the communications network by the dual-mode mobile device over a first access network, such as an LTE network. The network aggregation node may also intercept a second communication message transmitted from the second network node or from the dual-mode mobile device to the communications network (after causing the mobile device to transmit the second message) and determine from the intercepted second communication message a network identity and IP address associated with access of the communications network by the dual-mode mobile device over a second access network, such as a wireless (Wi-Fi network).

Once the identity of the mobile device and access networks are determined, the network aggregation node may receive downlink traffic sent from the communications network to the dual-mode mobile device, and transmit the received downlink traffic from the network aggregation node to the dual-mode mobile device via the second access network and/or via both access networks. For example, the network aggregation node may transmit or direct a first portion of the received downlink traffic to the dual-mode mobile device over the first access network, and transmit or direct a second portion of the received downlink traffic to the dual-mode mobile device over the second access network.

In doing so, the destination IP address of transmitted packets is not changed, and the IP routing and IP forwarding functions within the mobile device forwards packets from one access network radio interface to the other access network radio interface on the device, among other things.

Thus, in some embodiments, a communications network may provide aggregated communication services with respect to a core network that provides access to the Internet via an network aggregation node that is configured to direct uplink traffic sent from a mobile device to the core network via an LTE network, and direct downlink traffic sent from the core network to the mobile device via a wireless network.

By directing downlink traffic to different access networks using a network aggregation node, the systems and methods simplify the configuration of a network that provides services via aggregated networks, increasing the efficiency and effectiveness of the network with respect to downlink speeds and/or throughput for devices connected to the network. The network aggregation node is transparent with respect to other network nodes, and, therefore, may be implemented without changing or modifying any network components or user equipment, among other benefits.

The following description provides specific details for a thorough understanding of, and enabling description for, various embodiments of the technology. One skilled in the art will understand that the technology may be practiced without these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

### Example Network Configurations

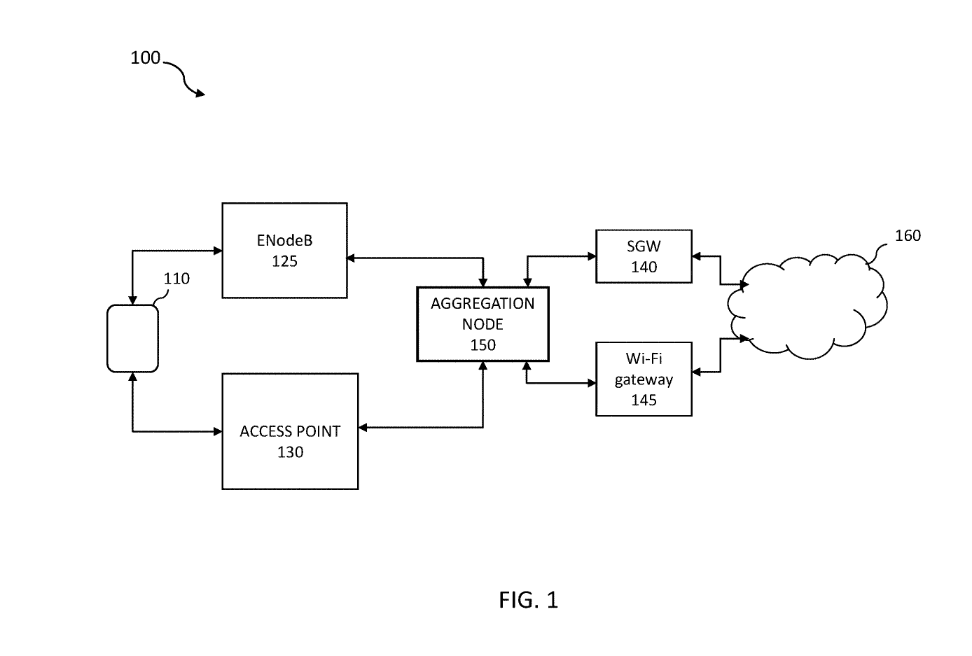

FIG. 1 illustrates aspects of a sample network environment 100 providing multiple network aggregation. A mobile device 110 or other user equipment (UE), such as a smart phone, tablet, laptop, and so on, may communicate with a core network 160, such as an Evolved Packet Core (EPC) network that includes an IP Multimedia System (IMS) network configured to Internet and other services.

The mobile device 110, which may be a dual-mode mobile device (e.g., containing two or more radios for communication over different networks) may access the core network 160 via various different access networks, such as a Universal Mobile Telecommunications System (UMTS) network, a Long Term Evolution (LTE) network, one or more wireless networks, and so on. For example, the mobile device 110 may connect to an LTE network via an Evolved Node B (ENodeB) component 125, such as a component implemented via an LTE small cell, and/or connect to a wireless network via an access point 130, such as a wireless router.

The wireless networks may employ any type of wireless protocol, including wireless local, wide, and metropolitan area network (WLAN, WWAN, WMAN, respectively) access protocols. For example, wireless protocols can include IEEE 802.16 (WiMAX), IEEE 802.20 Mobile Broadband Wireless Access (MBWA), Ultra Wideband (UWB), 802.11 wireless fidelity (Wi-Fi), Bluetooth standards, or other similar standards.

Each of the networks provides components and/or nodes configured and specific for handling communications to and from the mobile device 110. For example, the GSM/UMTS network may utilize a Mobile Switching Center (MSC) component and a Serving Mobile Location Center (SMLC). As another example, IMS-EPC (Evolved Packet Core) sets of components handle communications received via the LTE network or wireless networks. For example, a Mobile Management Entity (MME) acts as a control node for the LTE network, and a Serving Gateway and Packet Data Network Gateway (S/P-GW, or SGW and PGW) 140, and/or Wi-Fi Gateway 145 acts to serve and/or control data packets received via the wireless network and/or the LTE network.

Thus, the mobile device 110 may access the core network 160 via various access gateway servers, such as a Gateway GPRS Support Node (GGSN) for General Packet Radio Service (GPRS), a Packet Data Gateway (PDG) for Wi-Fi, Systems Architecture Evolution Gateway (SAE-GW), a Packet Data Network Gateway (PDN-GW) for 3GPP Long Term Evolution (LTE), an an Evolved Packet Data Gateway, or ePDG, and so on.

To ease the integration of an IMS network or other core network with Internet resources, various specifications (e.g., 3GPP specifications) use Internet Engineering Task Force protocols within the core network. An example of one such protocol is session initiation protocol (SIP). SIP is a signaling protocol used for creating, modifying and terminating two-party or multiparty sessions consisting of one or several media streams. Endpoints, such as access points, register with the core network in order to use IMS and other services.

For example, the core network 160 may include a Call Session Control Function (CSCF), which provides various SIP servers or proxies for processing signaling packets, performing communication session controls, hosting and executing services, and so on. For example, the core network may include a Proxy-CSCF (P-CSCF), which acts a first contact point or gateway for communications from the LTE network and/or wireless networks. The core network 160 may also include a Serving-CSCF (not shown), which performs session controls as the central node of the signaling plane of the core network, multiple application servers that provide application services, media servers, charging systems, and so on.

As described herein, the network environment 100 also includes a network aggregation node 150 that is configured to identify the mobile device 110 communicating with the core network 160 and/or the different access networks via which the mobile device is capable of accessing the core network 160. As shown in FIG. 1, the network aggregation node 150 is positioned (within the network) between an Evolved Node B (ENodeB) component 125 and the SGW 140. Similarly, the network aggregation node 150 is positioned (within the network) between the access point 130 and the Wi-Fi gateway 145.

The network aggregation node 150, therefore, is configured, located, and/or positioned to intercept messages (e.g., attach or handover messages) placed from the ENodeB 125 to the SGW 140 and/or from the access point 130 to the Wi-Fi gateway 145, transmit instructions back to the ENodeB 125 and/or access point 130, and/or transmit or direct network traffic (e.g., voice, text, and/or data communication packets) from the core network 160 (e.g., from content servers within the core network 160) to the mobile device 110 via one or more access networks from which the mobile device 110 is configured to connect to the core network 160.

The position of the network aggregation node 150, between the access point 130 and/or ENodeB 125 and the gateway nodes 140, 145, enables the node 150 to provide such functionality in a transparent fashion with respect to the various nodes of the network 100, because the node performs the interception of messages and direction of network traffic within an IP layer established between the access nodes 130, 125 and the gateway nodes 140, 145 of the network 100.

FIG. 1 and the discussion herein provide a brief, general description of a suitable computing environment 100 in which the systems and methods can be supported and implemented. Although not required, aspects of the systems and methods are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

In some embodiments, the mobile device 110 may include network communication components that enable the mobile device 110 to communicate with remote servers or other portable electronic devices by transmitting and receiving wireless signals using a licensed, semi-licensed, or unlicensed spectrum over a communications network, such as core network 160. In some cases, the communication network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks. As described herein, the communications network may also include third-party communications networks such as a Global System for Mobile (GSM) mobile communications network, a code/time division multiple access (CDMA/TDMA) mobile communications network, a 3rd or 4th generation (3G/4G) mobile communications network (e.g., General Packet Radio Service (GPRS/EGPRS)), Enhanced Data rates for GSM Evolution (EDGE), Universal Mobile Telecommunications System (UMTS), Long Term Evolution (LTE) network), Voice over LTE (VoLTE), IMS network, or other communications network.

### Examples of Aggregating Communication Services Via Multiple Networks

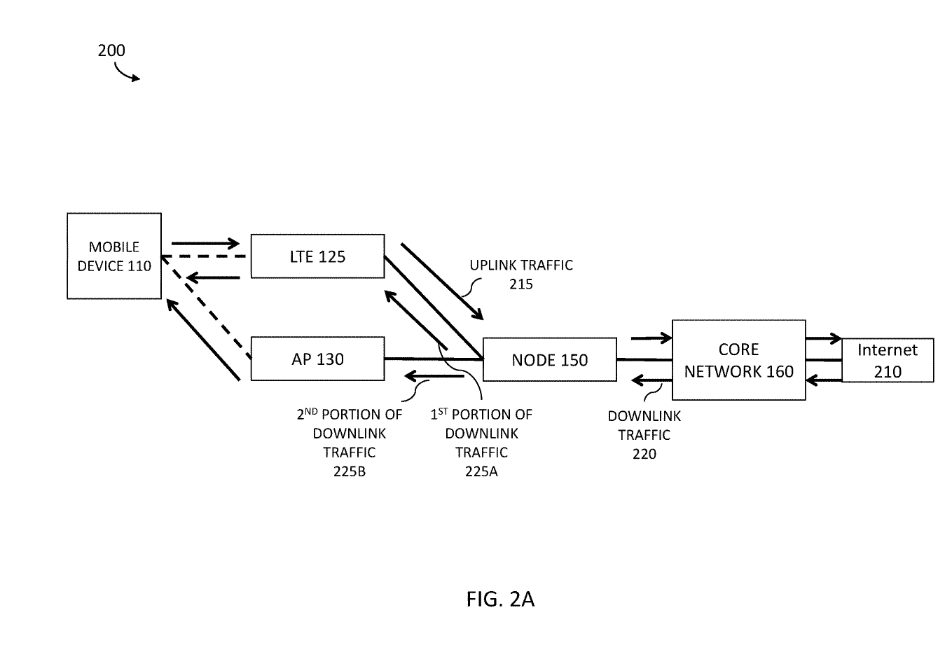

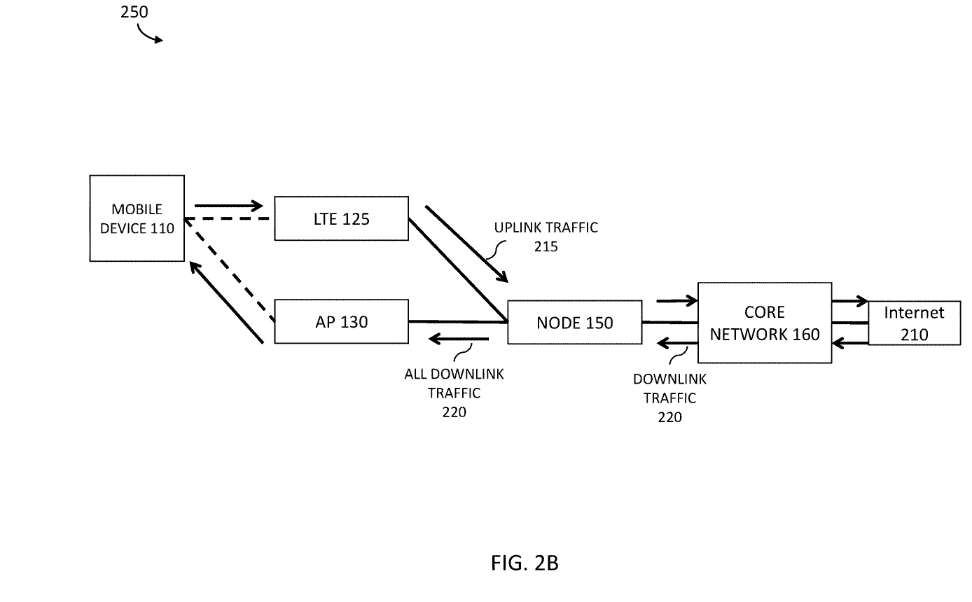

As described herein, the network aggregation node 150 directs downlink traffic (data and other packets) the mobile device 110 via one or more access networks over which the mobile device 110 is configured to receive communication services from the core network 160. FIGS. 2A-2B are diagrams illustrating the flow of traffic within a network.

As depicted in FIG. 2A, the mobile device 110 sends uplink traffic 220 from the ENodeB 125 (providing an LTE access network) to the Internet 210, which is provided by the core network 160. The aggregation node 150, which is transparent to the mobile device 110 and the ENodeB 125, intercepts the uplink traffic 215, and identifies the mobile device 110 and access networks through which the mobile device 110 is configured to send/receive communications. Additional details regarding the interception of uplink traffic and the identification of the mobile device 110 and access networks are described herein.

The network aggregation node 150 receives downlink traffic 220 from the core network 160, which is sent to the mobile device 110. Although the core network 160 directs the downlink traffic 220 to the mobile device 110 via the LTE access network (associated with the ENodeB 125), the network aggregation node 150 intercepts and/or receives the downlink traffic 220 and directs the downlink traffic to both the LTE small cell 120 and the access point 130. For example, the node may transfer a first portion 225A of the downlink traffic (e.g., a certain number or type of packets) to the mobile device 110 via the ENodeB 125, and may transfer a second portion 225B of the downlink traffic (e.g., a remaining number or different type of packets) to the mobile device 110 via the access point 130.

Thus, in this example, the network aggregation node 150 utilizes knowledge of two different access networks through which the mobile device 110 is connected, and splits the overall downlink traffic 220 into two different portions of traffic, each to be sent to the mobile device 110 over one of the access networks. The splitting or redirection of the network traffic over the two access networks, in some embodiments, increases the speed (2 times or more) at which the core network 160 sends the downlink traffic 220 to the mobile device 110, among other benefits.

FIG. 2B depicts a different, but similar, network traffic transfer scenario, where the network aggregation node intercepts the uplink traffic 215 sent via a first access network (e.g., the LTE network provided by the ENodeB 125), and transfers all the downlink traffic 220 sent to the mobile device 110 to a second, different, access network (e.g., a wireless network provided by the access point 130).

In such a scenario, the direction of downlink traffic to the access network that was not utilized for uplink traffic, and, in some embodiments, increases the speed (1.5 times or more) at which the core network 160 sends the downlink traffic 220 to the mobile device 110, among other benefits.

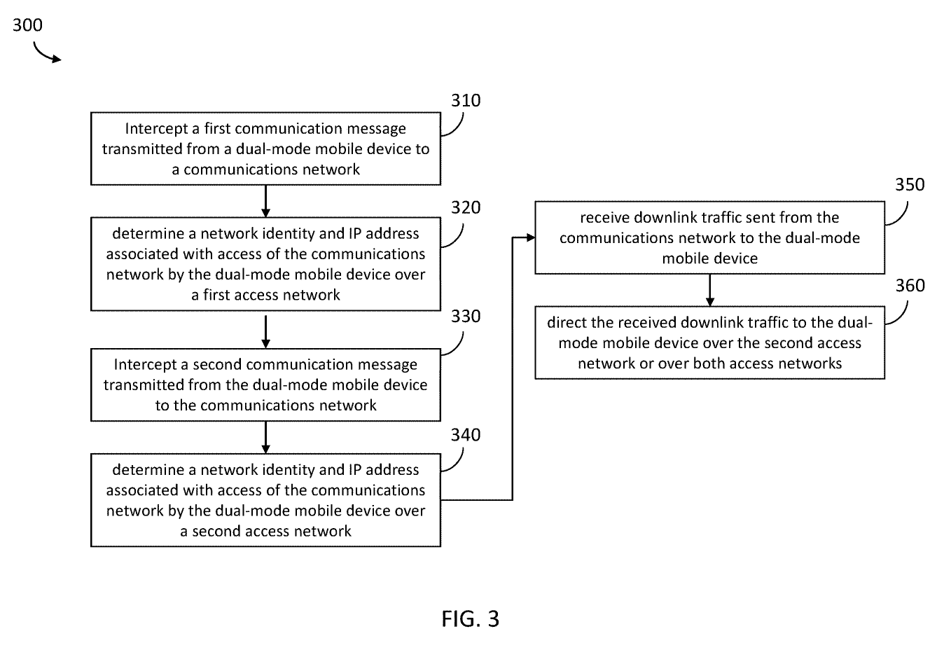

As described herein, the systems and methods perform various operations or methods for increasing the speed or throughput of a network by aggregating the use of multiple networks through which network traffic is transferred to a mobile device. FIG. 3 is a flow diagram illustrating a method 300 of directing traffic using a network aggregation node. The method 300 may be performed by the network aggregation node 150 and, accordingly, is described herein merely by way of reference thereto. It will be appreciated that the method 300 may be performed on any suitable hardware.

In operation 310, the network aggregation node 150 intercepts a first communication message transmitted from the mobile device 110 to the communications network (e.g., core network 160). For example, the node 150 may intercept a network attach message, handover message, or other messages sent by the mobile device 110 when attempting to connect to a network, such as the core network 160.

In operation 320, the network aggregation node 150 determines, from the intercepted first communication message, a network identity and IP address associated with access of the communications network by the dual-mode mobile device over a first access network. For example, the network aggregation node 150 may identify an International Subscriber Mobile Identity (IMSI) for the mobile device 110 and an IP address allocated to the IMSI by the first access network from the contents (e.g., header information), within the message and/or by querying another core network element with the information received from the header, such as using a Globally Unique Temporary ID (GUTI) for the device 110.

In operation 330, the network aggregation node 150 intercepts a second communication message transmitted from the mobile device 110 to the communications network, and determines, in operation 340, a network identity and IP address associated with access of the communications network by the mobile device 110 over a second access network.

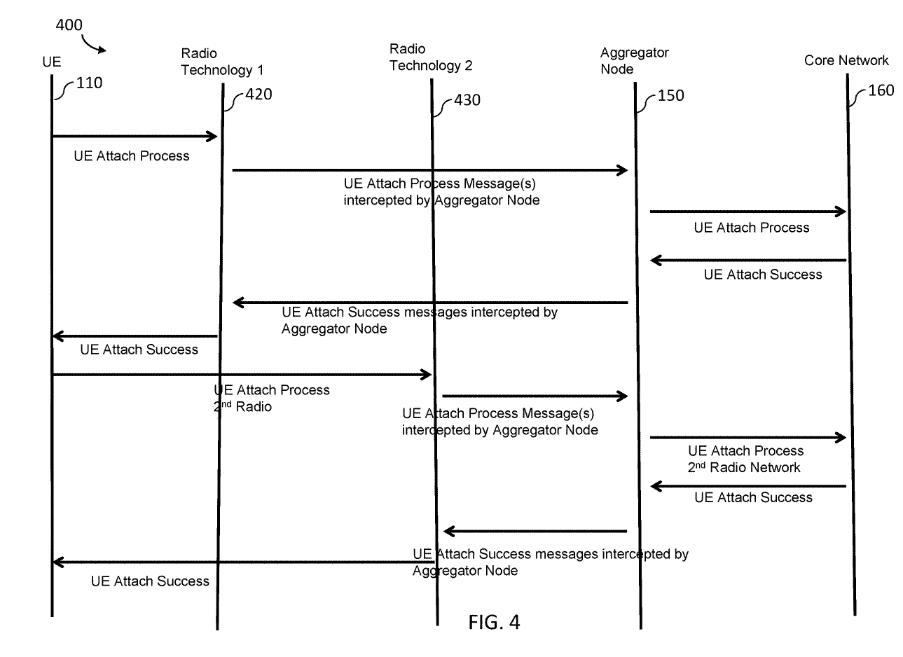

In some cases, the network aggregation node 150 causes or instructs the mobile device 110 to send the second communication message to the communications network via the second access network. FIG. 4 depicts the flow of signals between the mobile device 110, the access networks, and the core network 160.

The node 150 may, after intercepting the first communication message transmitted from the mobile device 110 to the communications network 160 via the first access network 420, returns a non-routable IP address (e.g., without a default gateway) for the second access network 430 to the mobile device 110.

The mobile device 110, in receiving the non-routable IP address, may then transmit the second communication message to the communications network via the second access network 430. Further, in some cases, the node 150 returns a routable address (e.g., with default gateway) to the device 110, and, later, intercept and block or prevent any uplink data transmitted from the second access network 430, which will causes the device 110 to transmit uplink data via the first access network 420.

The node 150 intercepts the message sent via the second access network 430, intercepts an acknowledgement (ACK) message from the core network 160, and transfers the ACK message to the mobile device 110 via the second access network 430. The node 150, therefore, determines the IP addresses for the two access networks 420, 430 by transparently intercepting the attach and acknowledgement message sent between the access networks 420, 430 and the core network 160.

Returning to FIG. 3, the network aggregation node 150, in operation 350, receives (or, intercepts) downlink traffic sent from the communications network to the dual-mode mobile device. In operation 360, transmits, directs, or otherwise transfers (or, causes to transfer) the received downlink traffic to the mobile device 110 via one or more of the access networks.

As a first example, the node 150 may transfer all downlink traffic to the access network not utilized for uplink traffic (see FIG. 2B). As a second example, the node 150 may transmit a first portion of the received downlink traffic to the mobile device 110 over the first access network, and transmit a second portion of the received downlink traffic to the mobile device 110 over the second access network.

As described herein, the network aggregation node may split the overall downlink traffic into a variety of different portions. For example, the node 150 may send a first type of network traffic, such as voice traffic (voice packets) to the mobile device 110 via an LTE access network, and send a second type of network traffic, such as data traffic (data packets) to the mobile device 110 via a wireless access network.

As another example, the node 150 may split the network traffic via one or more load balancing mechanisms, such as transferring one half of the traffic over one access network and the other half of the traffic over another access network, and/or splitting the network traffic over the two access networks such that an overall throughput (e.g., bits per second (bps) or packets per second) is maximized or is maintained above a threshold rate. Of course, the node 150 may employ other load balancing or packet transfer rules when allocating portions of downlink traffic to multiple access networks.

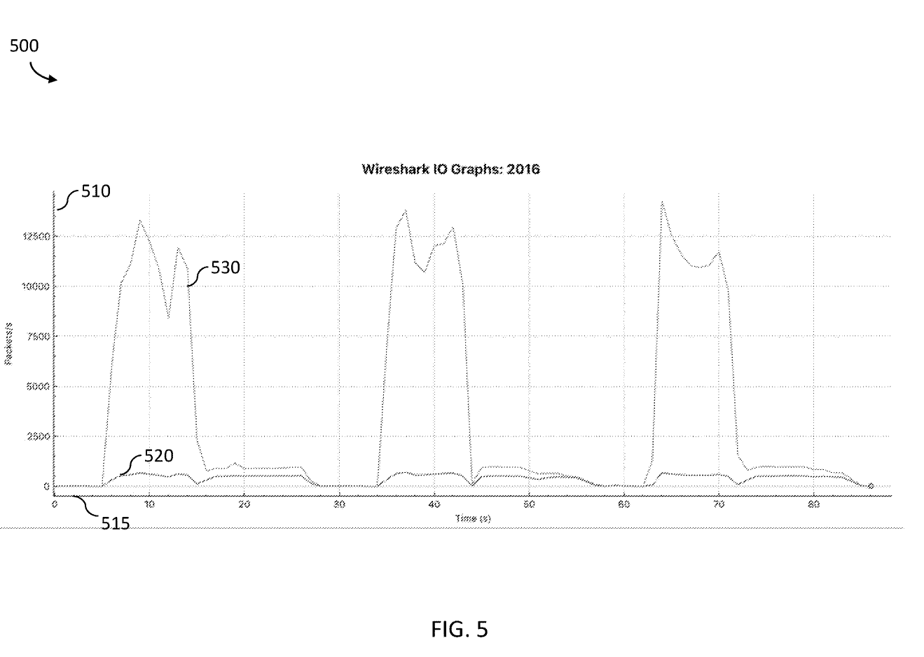

As described herein, the network aggregation node 150, when utilized by a core network 150 in sending network traffic to the mobile device 110, may provide downlink speeds greater than typical downlink speeds (e.g., in a network without the node 150). FIG. 5 is a graph 500 illustrating example results when utilizing the access point 130 solely for downlink traffic transmission.

The mobile device 110 (e.g., a Samsung S4 dual-mode device) sends uplink traffic to the core network via the LTE small cell (e.g., 10 MHz FDD), and receives downlink traffic from the core network 160 via the access point 130 (e.g., 802.11ac 2×2 access point), after the network aggregation node 150 intercepted and redirected the downlink traffic to the access point 130.

As shown in the graph 500, the throughput rate 510, in packets per second, with respect to the time 515 is around 12,500 packets/second for downlink speeds 530, and 1500 packets/second for uplink speeds 520. Thus, the node 150, in redirecting or routing the downlink traffic to the different access network, realized greater downlink speeds, as opposed to sending the downlink traffic over the same access network providing the uplink traffic, among other benefits.

Thus, by providing the network aggregation node 150 proximate to the core network 160, such as between a small cell component of an LTE access network and a gateway node of the core network 160 (and thus, within the IP layer established between the access network and the core network 160), the systems and methods described herein enable a network to allocate, direct, and/or transfer downlink traffic from the core network 160 to the mobile device 110 over various appropriate and/or certain access network. For example, the node 150 may facilitate the direction of uplink traffic sent from the mobile device 110 to the core network 160 via an LTE network (or other access network), and facilitate the direction of downlink traffic sent from the core network 160 to the mobile device 110 via a wireless access network, and/or both access networks, among other configurations.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively or additionally, network elements performing those functions could be replaced by two or more elements to perform portions of those functions. In addition, while processes, message/data flows, or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes, message/data flows, or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges. Those skilled in the art will also appreciate that the actual implementation of a database may take a variety of forms, and the term “database” is used herein in the generic sense to refer to any data structure that allows data to be stored and accessed, such as tables, linked lists, arrays, etc.

The teachings of the methods and system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the technology.

What is claimed is:

1. A method for managing network traffic within a communications network, the method comprising:
intercepting, at a network aggregation node associated with an internet protocol (IP) layer of the communications network, a first communication message transmitted from a dual-mode mobile device to the communications network;
determining, from the intercepted first communication message, a network identity and IP address associated with access of the communications network by the dual-mode mobile device over a first access network;
intercepting, at the network aggregation node associated with the internet protocol (IP) layer of the communications network, a second communication message transmitted from the dual-mode mobile device to the communications network;
determining, from the intercepted second communication message, a network identity and IP address associated with access of the communications network by the dual-mode mobile device over a second access network;
receiving, at the network aggregation node associated with the IP layer of the communications network, downlink traffic sent from the communications network to the dual-mode mobile device; and
transmitting the received downlink traffic from the network aggregation node to the dual-mode mobile device by:
transmitting a first portion of the received downlink traffic to the dual-mode mobile device over the first access network; and
transmitting a second portion of the received downlink traffic to the dual-mode mobile device over the second access network.

2. The method of claim 1, further comprising:
after intercepting the first communication message transmitted from the dual-mode mobile device to the communications network, returning, via the network aggregation node, a non-routable IP address to the mobile device associated with the second access network, which causes the mobile device to transmit the second communication message from the dual-mode mobile device to the communications network via the second access network.

3. The method of claim 1, wherein the first access network is a cellular communications access network, and wherein the second access network is a wireless network.

4. The method of claim 1, wherein the first access network is a Long Term Evolution (LTE) network, and wherein the second access network is a Wi-Fi network.

5. The method of claim 1, wherein the first access network is a Long Term Evolution (LTE) network, wherein the second access network is a Wi-Fi network; and
wherein the network aggregation node intercepts communications between an Evolved Node B (ENodeB) component of the first access network and a gateway component of the communications network.

6. The method of claim 1, wherein the communications network is an IP Multimedia System (IMS) network.

7. The method of claim 1, wherein the communications network is an Evolved Packet Core (EPC) network.

8. The method of claim 1, wherein the first communication message is a network attachment message.

9. The method of claim 1, wherein the first communication message is a handover message.

10. The method of claim 1, wherein the network identity and IP address associated with access of the communications network by the dual-mode mobile device over the first access network includes an International Subscriber Mobile Identity (IMSI) for the dual-mode mobile device and an IP address allocated to the IMSI by the first access network.

11. A non-transitory computer-readable medium whose contents, when executed by a computing system, cause the computing system to perform a method for handling network traffic within a communications network, the method comprising:
intercepting a first communication message transmitted from a dual-mode mobile device to the communications network;
determining, from the intercepted first communication message, a network identity and IP address associated with access of the communications network by the dual-mode mobile device over a first access network;
intercepting a second communication message transmitted from the dual-mode mobile device to the communications network;
determining, from the intercepted second communication message, a network identity and IP address associated with access of the communications network by the dual-mode mobile device over a second access network;
receiving downlink traffic sent from the communications network to the dual-mode mobile device; and
transmitting the received downlink traffic to the dual-mode mobile device by:
transmitting a first portion of the received downlink traffic to the dual-mode mobile device over the first access network; and
transmitting a second portion of the received downlink traffic to the dual-mode mobile device over the second access network.

12. The non-transitory computer-readable medium of claim 11, further comprising:
after intercepting the first communication message transmitted from the dual-mode mobile device to the communications network, returning, via the network aggregation node, a non-routable IP address to the mobile device associated with the second access network, which causes the mobile device to transmit the second communication message from the dual-mode mobile device to the communications network via the second access network.

13. The non-transitory computer-readable medium of claim 11, wherein a network aggregation node positioned between a small cell component of the first access network and a gateway of the communications network receives the downlink traffic sent from the communications network to the dual-mode mobile device and transmits the received downlink traffic to the dual-mode mobile device via the first access network and the second access network.

14. The non-transitory computer-readable medium of claim 11, wherein a network aggregation node positioned between a small cell component of the first access network and a gateway of the communications network determines from the intercepted first communication message and the intercepted second communication message the network identities and IP addresses associated with access of the communications network by the dual-mode mobile device over the first access network and the second access network.

15. The non-transitory computer-readable medium of claim 11, wherein the downlink traffic sent from the communications network to the dual-mode mobile device is received within an internet protocol (IP) layer of the communications network and transmitted to the dual-mode mobile device via the first access network and the second access network.

16. The non-transitory computer-readable medium of claim 11, wherein an internet protocol (IP) layer of the communications network determines the network identities and IP addresses associated with access of the communications network by the dual-mode mobile device over the first access network and the second access network.

17. The non-transitory computer-readable medium of claim 11, wherein the first access network is a Long Term Evolution (LTE) network, and wherein the second access network is a Wi-Fi network.

18. A communications network, comprising:
a Long Term Evolution (LTE) network;
a wireless network;
a core network that provides access to the Internet; and
a network aggregation node configured to:
direct uplink traffic sent from a mobile device to the core network via the LTE network; and
direct downlink traffic sent from the core network to the mobile device via the wireless network.

19. The communications network of claim 18, wherein the network aggregation node is configured to intercept communications between an Evolved Node B of the LTE network and a signaling gateway (SGW) of the core network.

20. The communications network of claim 18, wherein the network aggregation node is configured to intercept communications between the mobile device and the core network via an IP layer established between the LTE network and the core network.
